(19) United States
(12) Patent Application Publication
(10) Pub. No.: US 2011/0047570 A1
(43) Pub. Date: Feb. 24, 2011

(54) APPARATUS AND METHOD FOR QUICK NAVIGATION BETWEEN RECOMMENDATION SETS IN A TV CONTENT DISCOVERY SYSTEM

(75) Inventors: Ofer Weintraub, Hertzliya (IL); Eran Agmon, Tel Aviv (IL); Adi Eshkol, Pardes Hanna (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: ORCA Interactive Ltd., Raanana (IL)

(21) Appl. No.: 12/674,682

(22) PCT Filed: Sep. 3, 2008
(86) PCT No.: PCT/IB08/53555

§ 371 Date: Feb. 23, 2010

Related U.S. Application Data
(60) Provisional application No. 60/969,655, filed on Sep. 3, 2007.

(51) Int. Cl. H04N 5/445

(52) U.S. Cl. 725/40

(57) ABSTRACT

A method for quick navigation between recommendation sets in a TV content discovery system includes mapping of several physical buttons on a remote controller to a single virtual representation button on a TV screen. The virtual representation button provides a one click function of selecting and changing recommendation domains and/or recommendation sets within the recommendation domains. The virtual representation button may also be changed with the single click to indicate the status of the selected content

### CROSS REFERENCE TO RELATED APPLICATIONS

This application claims the benefit of U.S. Provisional Patent Application No. 60/969,655 filed 3 Sep. 2007, which is incorporated herein by reference in its entirety.

### FIELD OF THE INVENTION

The invention relates in general to systems and methods for discovery of content available for viewing in television (TV) systems, and in particular for quick navigation between content recommendation domains and recommendation sets therein using a single click action.

### BACKGROUND OF THE INVENTION

The control of TV content using a remote control user device (“remote controller”) in operative communication with the TV screen is known. As TV new services proliferate and become popular, more buttons are added to the remote controller to facilitate these new capabilities. On one band, the richness of these services (e.g. VOD, PVR, Games, User Generated Content, social network) is desired, as they attract new users and enhance the overall TV experience. On the other hand, this richness makes the remote control increasingly more complex to use, which in turn makes it increasingly less likely that large audiences can enjoy these new services. Therefore there is a need to keep developing and introducing new services while at the same time finding ways to simplify TV navigation with the remote controller.

### SUMMARY OF THE INVENTION

### Definitions

Recommendation: Any entity (e.g. content, game, service, etc.) that is provided to a user, based on some or all of the following inputs: a user profile, the entity's metadata, external metadata and at least one algorithm that connects them. Exemplary recommendations include (but are not limited to): video content, live content, user generated content, games, time-shift TV content, TV recordings, new services, friends, groups based on shared interests and the like.

Recommendation Domain: An aggregation of recommendations into a well defined category. Exemplary recommendation domains include broadcast, video on demand (VOD), user generated content (UGC), games, social based recommendations, external recommendations, recommendations by groups and experts, recommendations based on virtual identities and the like. Hereinafter, “recommendation domain” is referred to simply as “domain”.

Recommendation set: The N out of M recommendations presented to a user in a given domain (N representing a subset of M and fulfilling N<M). Exemplary recommendation sets include the entire list presented in the domain with reference to the N out of M recommendations. As used herein, the term “graphically presented” refers to the presentation, to a user, of at least one graphic image as opposed to the presentation of just text.

In order to simplify navigation of TV content and overcome the increased complexity required from remote controllers, the invention provides a solution that includes mapping of several physical buttons on the remote controller to a single virtual representation button (also referred to as “icon”) on the TV screen. The icon is in essence a graphical representation of one or more remote buttons on the user device (referred to simply as “remote buttons”). The icon provides a “one click” function of “navigation” (selecting and changing recommendation domains and/or sets within the recommendation domains). Hence, although the user needs to interact with different physical remote buttons, the perception is of single on-screen button that changes in behavior according to single-click actions on the remote controller. This concept makes it easier to use and remember various services, as they seem to be controlled by a single virtual button. We note that “TV screen” is used herein. to represent any screen or display that can exhibit content or service, including (but not limited to) a mobile phone display and a computer display. Hereinafter, “icon” refers to any virtual representation button appearing on the TV screen in conjunction with the “one click” function as defined above. In some embodiments, the icon may have the shape of a compass. The compass shape of the icon is exemplary, and is in no way limiting. Other buttons or mechanisms that allow the “one click” navigation between domains and recommendation sets should be considered as covered by the invention (see e.g. FIGS. 4-7).

The invention provides a method for presentation and selection of content on a TV screen. In an embodiment, a remote controller is in operative communication with the TV screen. The remote controller uses customary buttons (such as “OK”, “UP”, DOWN” “LEFT” AND “RIGHT”) for navigation, as known in the art. The TV screen may exhibit a single domain, see FIG. 1, or may exhibit simultaneously two domains, see FIG. 4, each domain having its own recommendation set. One click changes are made between recommendation sets of a given domain, from a single domain to another single domain, or from a set of two domains to another set of two domains. Exemplarily (see FIGS. 1-7), the OK remote button always changes recommendations sets and the DOWN button always changes a single domain to another single domain, or a two set domain to another two set domain. The exact settings of buttons (e.g. OK for recommendation sets and DOWN for domain changes) are provided in the configuration of the system. One can think of the OK button as a cyclic function that rotates recommendations sets in one or two domains and of the DOWN button as a cyclic function that changes domains. If for example there are ten domains, and two domains are presented on the screen each time, one will need 5 DOWN clicks to navigate through all ten domains. Note that in some embodiments, yet another button (e.g. LEFT) may be used to change a recommendation set of only one of two domains, leaving the recommendation set of the other domain unchanged. In some embodiments, a change of domains is typically accompanied by a change of the icon. The change of the icon helps the user to remember the presently shown domain. The user is then empowered so sift through a large amount of content (i.e. recommendation domains and recommendation sets) with the ease of a single-click.

In examples shown in detail with reference to FIGS. l-7, the icon is used to change a recommendation set by pressing the OK button and to change a recommendation domain by pressing the DOWN button. Although a user clicks the OK remote controller button to navigate between recommendations sets and the DOWN button to switch domains, the user's perception is of a single button on the screen that reacts to “clicks” on the remote buttons while the action related to each remote button click is effected on the screen. In addition to changing recommendation sets, the click on the OK button may rotate the icon (e.g. a compass) while changing a recommendation set. Similarly, in addition to switching domains, the click on the DOWN button may change the shape of the icon from a compass to a circle. The changes in icon shape are also provided in the configuration.

The icon may be activated by several mechanisms. For example, the operator may assign for its activation a shortcut button (e.g. the GREEN button on the user device) or it may be activated via some menu on the TV screen. The first domain activated by the shortcut button is the default domain (e.g. VOD) as configured by the vendor or operator. The default domain includes a default recommendation set. The user may now change the default recommendation set (or any currently displayed recommendation set) to another recommendation set in the same domain by a single click on one remote button (e.g. the OK button). The user may change any exhibited domain to another domain by a single click on another remote button (e.g. the DOWN button). The user may further access a particular recommendation of a set by using another remote button, e.g. the UP or LEFT button.

### BRIEF DESCRIPTION OF THE DRAWINGS

The invention is herein described, by way of example only, with reference to the accompanying drawings, wherein:

FIG. 1 shows a TV screen with a graphic representation of a display compass button and a first domain including a first recommendation set;

FIG. 2 shows a TV screen with the graphic representation of the display compass button and the first domain including a second recommendation set;

FIG. 3 shows a TV screen with the graphic representation of the display compass button and a second domain including a first recommendation set;

FIG. 4 shows a TV screen with a graphic representation of the display compass button, a third domain with a first recommendation set and a fourth domain with a first recommendation set;

FIG. 5 shows the TV screen of FIG. 4, wherein the first recommendation set of the third domain is changed to a second recommendation set;

FIG. 6 shows the TV screen of FIG. 5, wherein the first recommendation set of the fourth domain is changed to a second recommendation set;

FIG. 7 shows the TV screen of FIG. 4, wherein the third domain and the fourth domain are changed respectively to a fifth domain and a sixth domain.

### DETAILED DESCRIPTION OF THE INVENTION

Throughout this application, a recommendation domain and/or recommendation set, alone or in combination, are also referred to as “content related entity” or simply “entity”. The numbering “first”, “second”, etc. as applied to recommendation sets define the status of these sets within a given domain and indicate that these sets differ from each other and include different recommendations. This is also reflected in the different numerals used to mark each set. Therefore, it is to be understood that a first recommendation set in a first domain is different from a first recommendation set in a second domain, a third domain, etc., and that a second recommendation set in a first domain is different from a second recommendation set in a second domain, in a third domain, etc.

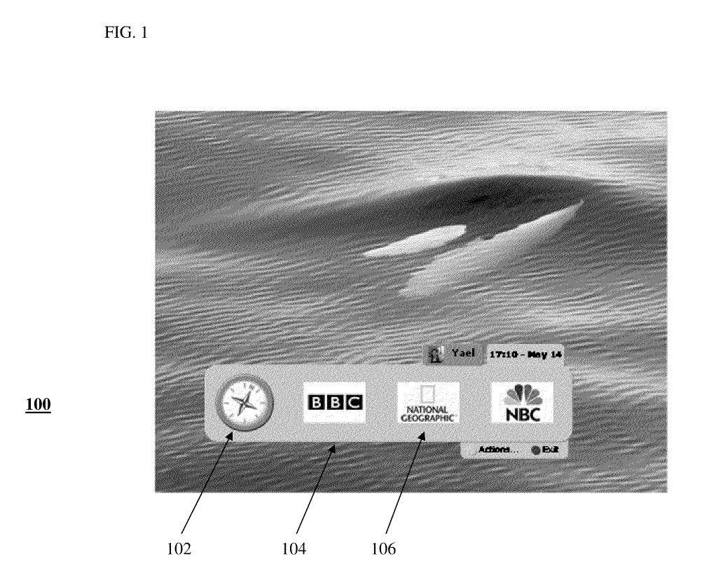

FIG. 1 shows a TV screen 100 with a graphic representation of an icon in the form of a compass button 102 and a first domain 104 (arranged horizontally) which includes a first recommendation set 106. Domain 104 represents broadcast channels (a.k.a. live channels) and first recommendation set 106 includes recommendations BBC, National Geographic and NBC. Screen 100 may represent a default screen, in which case both domain 104 and recommendation set 106 represent default entities. The default screen is arrived at by pressing on a pre-determined button (e.g. GREEN) on the remote controller or by other means (e.g. a TV Menu). Recommendation set 106 is further connected to other inputs as described above e.g. the user's profile (“Yael”) as shown in this figure.

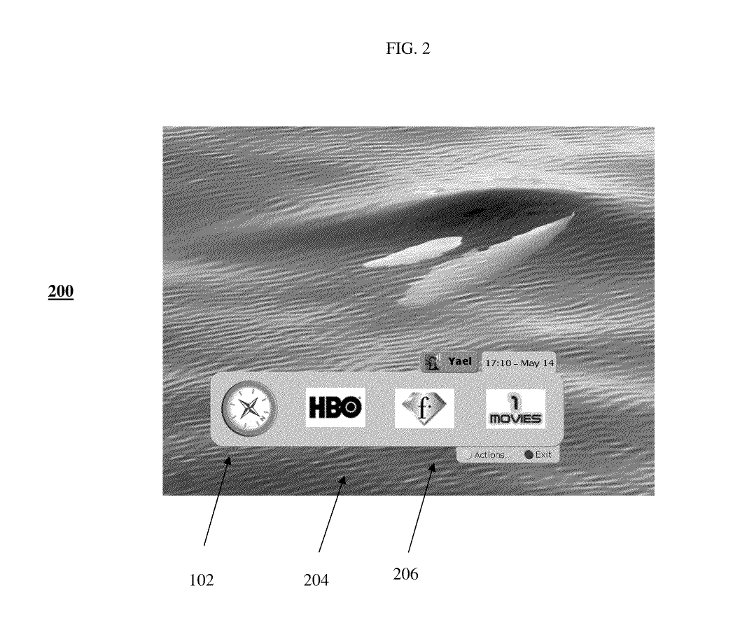

FIG. 2 shows the result of a “one click” pressing on the OK button of a remote controller (not shown). This click causes the TV screen to change to a screen 200 which includes compass button 102 and first domain 104, which now includes a second recommendation set 206. As in FIG. 1, domain 104 represents broadcast channels. Recommendation set 206 includes the HBO, Fashion and the Movies channels. The click on the OK button changed the recommendation set in domain 104 from first recommendation set 106 to second recommendation set 206, and also rotated the compass button by 90 degrees.

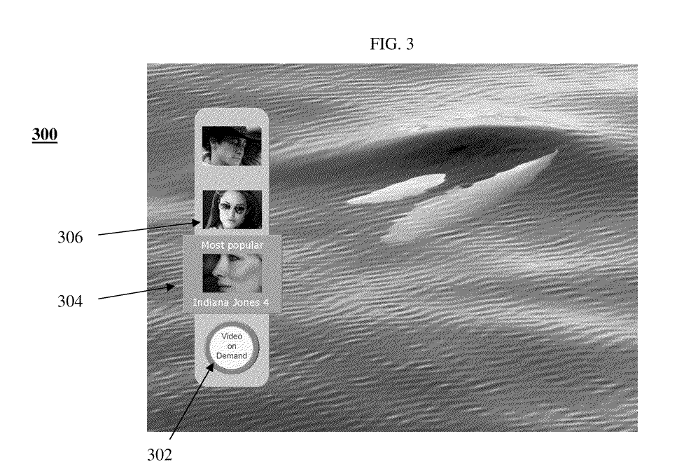

FIG. 3 shows the result of another click on the DOWN button of the remote controller. This click causes the TV screen to change to a screen 300 (either from one of screens 100 or 200 or from a starting screen with a vertical default domain and recommendation set). Screen 300 includes a graphic representation of an icon in the form of a round button icon 302 with “Video on Demand” written therewithin and a second domain 304 (arranged vertically). Domain 304 represents VOD and includes a first recommendation set 306 with “most popular” recommendations. It should be noted that this does not limit us to show only “Most Popular” recommendations in this recommendations set (e.g. other types of recommendation like “user rating” could be part of the recommendation set).

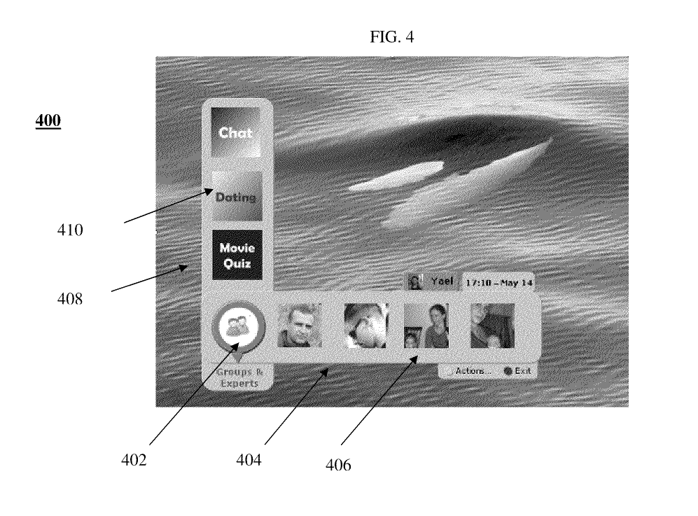

FIG. 4 shows the result of a click on the DOWN button of the remote controller when the TV screen is in a two domain mode (meaning the one-clicks are applied when a screen already includes two domains as shown). This click causes the TV screen to change to a screen 400, which includes a third (horizontal) domain 404 with a first recommendation set 406 and a fourth (vertical) domain 408 with a first recommendation set 410, as well as to exhibit an icon in the form of a round button 402. Horizontal domain 404 represents “Friends” and vertical domain 408 represents “Applications”. Recommendation set 406 includes recommendations Movie Quiz, Dating and Chat (all applications related to “Friends”).

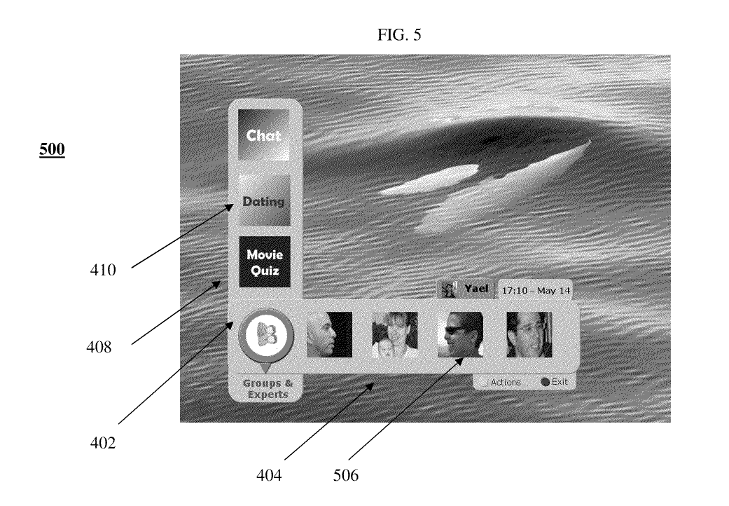

FIG. 5 shows the result of another click on the DOWN button of the remote controller which changes the TV screen of FIG. 4 to a screen 500, in which the first recommendation set 406 of domain 404 of FIG. 4 is changed to a second recommendation set 506, which includes other applications related to “Friends”. Vertical domain 408 is unchanged from FIG. 4. The click on the DOWN button also rotated the icon 402 by 90 degrees relative to its position in FIG. 4.

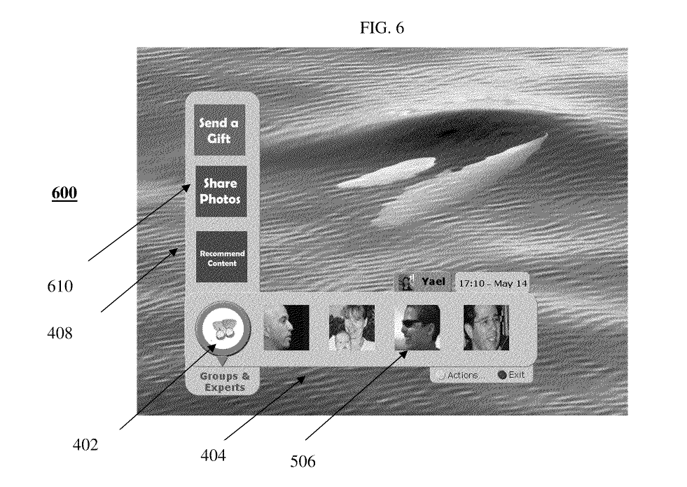

FIG. 6 shows the TV screen of FIG. 5 as a screen 600, wherein first recommendation set 410 of domain 408 in FIG. 5 is changed to a second recommendation set 610 including recommendations Content, Share Photos and Send a Gift. Domain 404 and recommendation set 506 are unchanged from FIG. 5. This screen was arrived at by activation of icon 402 through again clicking on the OK button, which caused icon 402 to rotate by another 90 degrees. In this configuration, an even click of the OK button is used to change the recommendation set on the vertical domain whereas an odd click of the OK button changes the horizontal recommendation set belonging to the “Friends” domain.

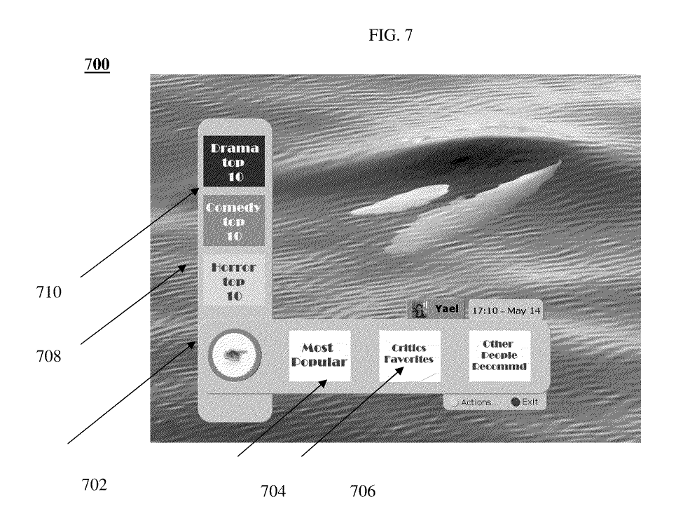

FIG. 7 shows a TV screen 700 with a graphic representation of an icon in the form of a round button 702, which is different from both buttons 302 and 402. The TV screen also includes a graphic representation of a fifth domain 704 with a first recommendation set 706 representing recommendation engines and a sixth domain 708 with a first recommendations set 710 representing genre top 10 lists. This screen was arrived at by clicking again on the DOWN button and activating again the icon. In this case, the change of the icon signifies the change in domains.

While the invention has been described with respect to a limited number of embodiments, it will be appreciated that many variations, modifications and other applications of the invention may be made. Those skilled in the art will appreciate that the invention can be embodied by other forms and ways, within the scope of the invention. The embodiments described herein should be considered as illustrative and not restrictive.

1. A method for enabling a user to present and select content on a television (TV) screen, the user having a user device which operatively communicates with the TV screen, the method comprising the steps of:
a) on the TV screen, graphically displaying a virtual representation button and graphically presenting a content related entity including a given recommendation domain having a recommendation set; and
b) upon a single click action of the virtual representation button performed by invoking a remote button on the user device, selecting and changing the given content related entity to another content related entity.

2. The method of claim 1, wherein the given content related entity includes a first recommendation domain having a first recommendation set and wherein the step of selecting and changing the given content related entity includes changing the first recommendation set to a second recommendation set.

3. The method of claim 1, wherein the given content related entity includes a first recommendation domain having a first recommendation set and wherein the step of selecting and changing the content related entity includes changing the first recommendation domain having a first recommendation set to a second recommendation domain having a first recommendation set.

4. The method of claim 1, wherein the given content related entity includes a first recommendation domain having a first recommendation set and a second recommendation domain having a second recommendation set and wherein the step of selecting and changing the content related entity includes changing the first recommendation set in the first recommendation domain to a second recommendation set in the first recommendation domain and changing the first recommendation set in the second recommendation domain to a second recommendation set in the second recommendation domain.

5. The method of claim 1, wherein the given content related entity includes a first recommendation domain having a first recommendation set and a second recommendation domain having a second recommendation set and wherein the step of selecting and changing the content related entity includes changing the first recommendation domain having a first recommendation set to a third recommendation domain having a first recommendation set and changing the second recommendation domain having a first recommendation set to a fourth recommendation domain having a first recommendation set

6. The method of claim 1, wherein the step of, upon a single click of the virtual representation button performed by invoking a remote button on the user device, selecting and changing the given content related entity to another content related entity includes changing the appearance of the virtual representation button.

7. The method of claim 1, wherein the virtual recommendation button is in the shape of a compass.

8. The method of claim 1, wherein the content related entity is a default content related entity arrived at by invoking a dedicated remote button on the user device.

9. The method of claim 1, wherein the content related entity is a content related entity arrived at by a previous single click action on the virtual representation button.
